(19) United States
(12) Patent Application Publication
(10) Pub. No.: US 2022/0270115 A1
(43) Pub. Date: Aug. 25, 2022

(54) TARGET SELECTION SYSTEM, TARGET SELECTION METHOD AND NON-TRANSITORY COMPUTER-READABLE RECORDING MEDIUM FOR STORING TARGET SELECTION PROGRAM

(71) Applicant: HITACHI, LTD., Tokyo (JP)

(72) Inventors: Kazuki YAMANE, Tokyo (JP); Kazuaki TOKUNAGA, Tokyo (JP); Kazuyuki OOTA, Tokyo (JP); Hiroyuki NAMBA, Tokyo (JP)

(21) Appl. No.: 17/439,493

(22) PCT Filed: Dec. 16, 2020
(86) PCT No.: PCT/JP2020/046888

§ 371 Date: Sep. 15, 2021

(51) Int. Cl. G06Q 30/02; G06N 5/04

(52) U.S. Cl. CPC G06Q 30/0201; G06N 5/046

(57) ABSTRACT

A learner generation unit generates, as a learner group, a plurality of learners that learned a correspondence of an attribute and an outcome in each of a plurality of learning data sets extracted from a data group associated with an attribute and an outcome of each of the targets. A target selection unit applies the learner group selected for inference to an inference data set and predicts, for each of the learners, an outcome corresponding to an attribute in the inference data set, calculates, for each attribute in the inference data set, at least one of an average of the outcomes predicted for each of the learners or an index value expressing an uncertainty of the outcomes, and selects, from the inference data set, the target to which the policy is to be executed based on at least one of the calculated average or the calculated index value.

### TECHNICAL FIELD

The present invention relates to a target selection system, a target selection method, and a non-transitory computer-readable recording medium for storing a target selection program.

### BACKGROUND ART

There are cases where it is desirable to execute a policy for a specific target (target in which high compensation such as revenue or purchase rate can be expected) by widening the scope of that target. For example, there are cases where the direct marketing activities, such as DM distribution, are conducted by widening the target customer attributes pursuant to the expansion of business.

Here, when the results of policies to be executed to a certain target are unknown, there are conventional technologies that select the policy to be executed using the Bandit algorithm to maximize the effect.

For example, PTL 1 discloses a technology of using the Bandit algorithm and calculating the items to be recommended to a sub group of a group consisting of a plurality of users as its members. Moreover, NPTL 1 discloses a technology of modeling the recommendation of a news article to users as a contextual Bandit problem, and selecting the article to be recommended to users based on the context information related to the users and the article.

### CITATION LIST

### Patent Literature

[PTL 1] Japanese Unexamined Patent Application Publication (Translation of PCT Application) No. 2015-513154

[NPTL 1] Lihong Li, Wei Chu, John Langford, Robert E. Schapire, “A Contextual- Bandit Approach to Personalized News Article Recommendation,” Presented at the Nineteenth International Conference on World Wide Web (WWW 2010), 2010.

### SUMMARY OF THE INVENTION

### Problems to be Solved by the Invention

Nevertheless, with the foregoing conventional technologies, since a policy that may not necessarily be optimal for a new target is selected randomly at a constant probability, the selection becomes more inefficient as the number of policy candidates is greater, and there is a problem in that the “useless selection” of policies tends to occur.

Moreover, considered may be using Bayesian estimation and learning the probability distribution of the effects of the policy, and estimating the as-yet-unknown effects depending on the new target. Nevertheless, as a result of using Bayesian estimation, there is a problem in that much processing time and computer resources are required.

The present invention was devised in view of the foregoing problems, and an object of this invention is to estimate, with higher accuracy, the effects depending on the new target based on a lighter calculation load.

### Means to Solve the Problems

In order to achieve the foregoing object, the present invention provides a target selection system which selects a target to which a policy is to be executed, comprising: a learner generation unit which generates, as a learner group, a plurality of learners that learned a correspondence of an attribute and an outcome in each of a plurality of learning data sets extracted from a data group associated with an attribute and an outcome of each of the targets; and a target selection unit which applies the learner group selected for inference to an inference data set extracted from the data group and predicts, for each of the learners, an outcome corresponding to an attribute in the inference data set, calculates, for each attribute in the inference data set, at least one of either an average of the outcomes predicted for each of the learners or an index value expressing an uncertainty of the outcomes, and selects, from the inference data set, the target to which the policy is to be executed based on at least one of either the calculated average or the calculated index value.

### Advantageous Effects of the Invention

According to the present invention, it is possible to estimate, with higher accuracy, the effects depending on the new target based on a lighter calculation load.

### BRIEF DESCRIPTION OF DRAWINGS

FIG. 1 is a diagram showing a configuration example of the target selection system.

FIG. 2 is a diagram showing a format example of the customer attribute data (for learning) handled by the learning engine.

FIG. 3 is a diagram showing a format example of the customer attribute data (for prediction) handled by the policy target selection engine.

FIG. 4 is a diagram showing an example of the prediction result of the purchase amount of the current month predicted by the learner.

FIG. 5 is a diagram showing an example of the data structure of the policy target list file.

FIG. 6 is a flowchart showing an example of the overall processing of the target selection system.

FIG. 7 is a flowchart showing an example of the learner group creation processing.

FIG. 8 is a flowchart showing an example of the prediction learner group selection processing.

FIG. 9 is a flowchart showing an example of the concept drift occurrence determination processing.

FIG. 10 is a flowchart showing an example of the policy target list creation processing.

FIG. 11 is a flowchart showing an example of the policy execution processing.

FIG. 12 is a diagram showing the data structure of the policy target list file of the modified example.

FIG. 13 is a diagram showing a hardware configuration example of the computer.

### DESCRIPTION OF EMBODIMENTS

An embodiment of the present invention is now explained with reference to the appended drawings. Note that the embodiment explained below is not limited to the claimed invention. Moreover, the various elements and all of their combinations explained in the embodiment may not necessarily be essential for the solution to be provided by the present invention. The illustration and explanation of configurations of the present invention which are essential, but known, may be omitted. Moreover, the integration and distribution of the respective elements illustrated in the respective diagrams are merely examples, and the integration and distribution of the respective elements may be performed suitably from the perspective of processing load or efficiency.

In the following explanation, while information may be explained in a table format, the information may be data of any kind of structure, for example, the information may also be explained in a CSV format. Moreover, in the following explanation, the configuration of the respective tables is an example, and one table may be divided into two or more tables, or all or a part of two or more tables may be one table. Moreover, in the following explanation, while it is explained that information is stored in a DB (Data Base), the DB is an example of a storage unit. Moreover, while it is explained that the learner is stored in a storage, the storage is also an example of a storage unit. Moreover, information in which the storage location thereof is not specified is also stored in some kind of storage unit.

In the following explanation, since “XXX engine” is a processor such as a CPU (Central Processing Unit) which executes programs and performs processing by coordinating with a memory, it may also be referred to as “XXX unit”.

(Configuration of Target Selection System S)

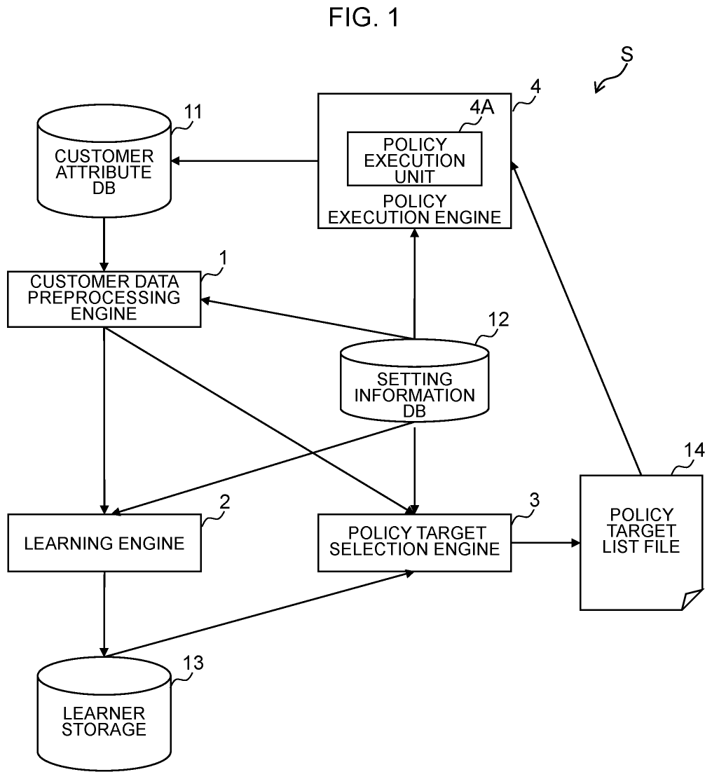

FIG. 1 is a diagram showing a configuration example of a target selection system S. The target selection system S is configured by including a customer data preprocessing engine 1, a learning engine 2, a policy target selection engine 3, a policy execution engine 4, a customer attribute DB 11, a setting information DB 12, a learner storage 13, and a policy target list file 14. The target selection system S is built on one computer or on multiple computers that are linked.

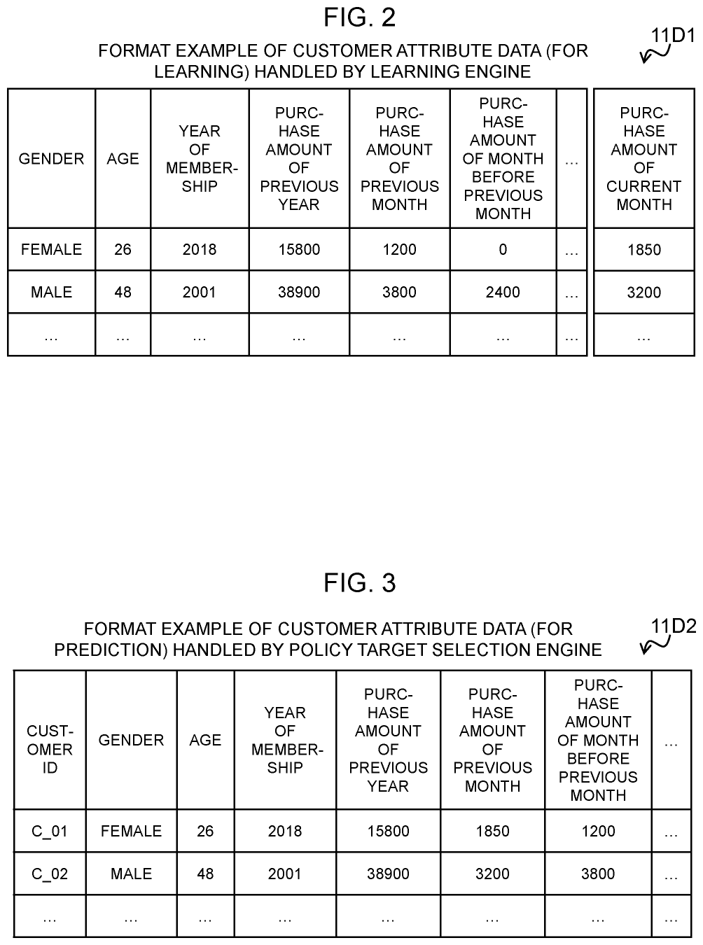

The customer data preprocessing engine 1 generates the customer attribute data (for learning) 11D1 (FIG. 2) to be used by the learning engine 2 in creating a learner from the customer attribute data stored in the customer attribute DB 11. The customer data preprocessing engine 1 uses a learning data reference query acquired from the setting information DB 12 to create, based on sampling with replacement, N-sets (N is 2 or more, preferably 10 or more) of the customer attribute data (for learning) 11D1 from the customer attribute data stored in the customer attribute DB 11.

FIG. 2 is a diagram showing a format example of the customer attribute data (for learning) 11D1 handled by the learning engine 2. The customer attribute data (for learning) 11D1 includes the items of gender, age, year of membership, purchase amount of previous year, purchase amount of previous month, purchase amount of month before previous month, and purchase amount of current month. Gender, age, and year of membership are examples of customer attributes.

Moreover, the customer data preprocessing engine 1 generates the customer attribute data (for prediction) 11D2 (FIG. 3) to be used by the policy target selection engine 3 in creating the policy target list file 14 from the customer attribute data stored in the customer attribute DB 11. The customer data preprocessing engine 1 uses a prediction data reference query acquired from the setting information DB 12 to create a set of the customer attribute data (for prediction) 11D2 from the customer attribute data stored in the customer attribute DB 11.

FIG. 3 is a diagram showing a format example of the customer attribute data (for prediction) 11D2 handled by the policy target selection engine 3. The customer attribute data (for prediction) 11D2 includes the items of customer ID, gender, age, year of membership, purchase amount of previous year, purchase amount of previous month, and purchase amount of month before previous month.

The learning engine 2 performs learning for each of the N-sets of the customer attribute data (for learning) 11D1 created by the customer data preprocessing engine 1 and creates N-number of learners, and stores the created learners in the learner storage 13. The learning engine 2 creates N-number of learners (learner (1), learner (2), . . . learner (N)) according to setting information such as the loop count N and learning algorithm for creating the learner acquired from the setting information DB 12.

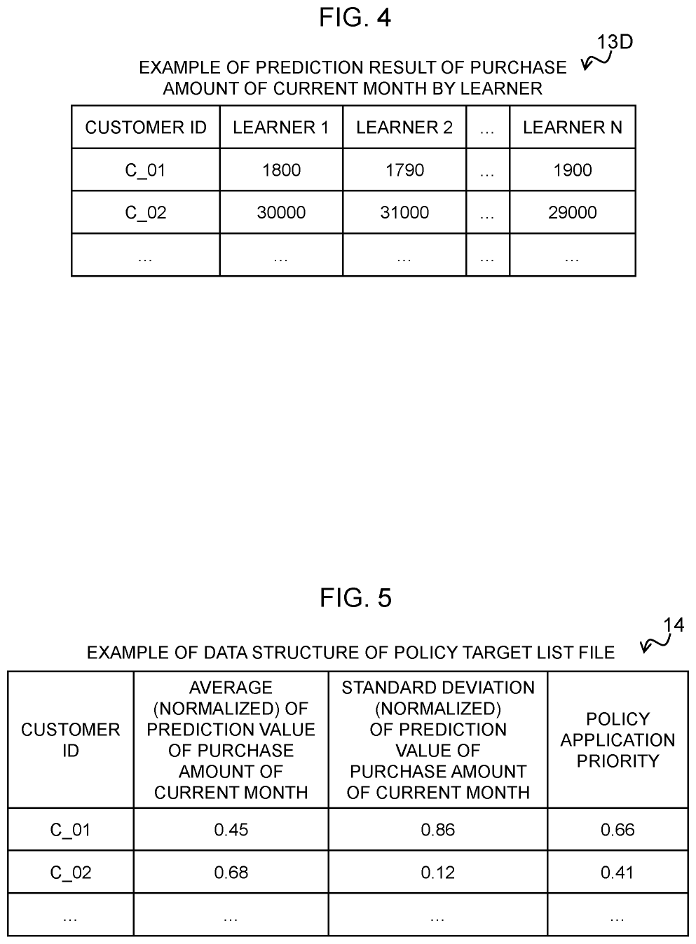

An inference engine of the policy target selection engine 3 acquires an ID of a learner for prediction from the setting information DB 12, and predicts the purchase amount of the current month of each customer (for each customer ID) of the customer attribute data (for prediction) 11D2 by using each of the N-number of learners stored in the learner storage 13. FIG. 4 is a diagram showing an example of the prediction result 13D of the purchase amount of the current month predicted by the learner.

Subsequently, the policy target selection engine 3 calculates the average and standard deviation of the predicted value of the purchase amount of the current month for each customer ID from the prediction result 13D of the purchase amount of the current month. The policy target selection engine 3 normalizes the average, for example, by dividing the average of each customer ID by the maximum value among the averages of a plurality of customer IDs. Similarly, the inference engine of the policy target selection engine 3 normalizes the standard deviation, for example, by dividing the standard deviation of each customer ID by the maximum value among the standard deviations of a plurality of customer IDs. It is thereby possible to obtain the “average (normalized)” of the predicted value of the purchase amount of the current month and the “standard deviation (normalized)” of the predicted value of the purchase amount of the current month corresponding to each customer ID.

Subsequently, the policy target selection engine 3 calculates the policy application priority to be assigned to each customer ID based on a weighted average as shown in Formula (1), for example, by using the “average (normalized)” and the “standard deviation (normalized)” corresponding to each customer ID. a in Formula (1) is 0 or more and 1 or less, and in this embodiment a manually set value of a=0.5 is used. Policy application priority =a x average (normalized) +(1−a)×standard deviation (normalized) . . . (1)

The fact that the “average (normalized)” is high means that high compensation (outcome) can be expected by executing the policy. In order to find a good customer, the policy should be preferentially executed to a customer with a high average.

Moreover, the fact that the “standard deviation (normalized)” is high means that there is variation in the compensation to be obtained by executing the policy and that there is uncertainty, and that the confidence (that is, (1−standard deviation)) is low.

The confidence tends to be a large value when prediction is performed to data with numerous similar examples of customer attributes in past data, and tends to be a small value when prediction is performed to data with few similar examples of customer attributes in past data. Data with numerous similar examples in past data tend to have similar prediction results even with different learners since similar data constantly appear in a certain quantity or more in the learning by each learner. Meanwhile, data with few similar examples in past data tend to have different prediction results with different learners since similar data hardly appear in the learning by each learner. Thus, data with numerous similar examples of customer attributes in past data will have similar prediction results and the standard deviation will be small, and the confidence will be high. Meanwhile, when there are only a few similar examples, the prediction results will vary and the standard deviation will be great, and the confidence will be low.

In other words, in order to approach a customer belonging to an unchartered segment, the policy should be preferentially executed to a customer with a low confidence.

Thus, by preferentially executing the policy in ascending order from the highest policy application priority, which gives consideration to both average and confidence of the prediction result, as shown in Formula (1), it will be easier to approach a good customer belonging to an unchartered segment.

Note that it is also possible to calculate one of either the average or the confidence of the prediction result (or index value representing the uncertainty of the prediction result) and decide the policy application priority based on either one.

However, a described above may also be automatically calculated. For example, a is obtained wherewith, among the upper M1-number of customers of the policy application priority of Formula (1), the number of customers not included in the upper M2-number of customers of the average (normalized) of the predicted value of the purchase amount of the current month will be within p% of the total number of customers (total number of lines of the policy target list file 14). As a result, when selecting a target to which the policy is to be executed by using the policy application priority, it is possible to limit, to a certain extent, the number of customers that will be excluded as the target of policy execution in comparison to the case of selecting a target to which the policy is to be executed only by using the average of the purchase amount. However, M1 and M2 are predetermined numbers, and M2=M1 or M2≠M1. Moreover, p is a predetermined percentage. This a may be used in the subsequent calculation of the policy application priority onward.

The thus calculated average (normalized), standard deviation (normalized), and policy application priority of each customer ID will be, for example, as shown in FIG. 5. FIG. 5 is a diagram showing an example of the data structure of the policy target list file 14. A customer having a higher value of the policy application priority shown in FIG. 5 will be the target to which the policy is to be preferentially executed.

The policy execution engine 4 includes a policy execution unit 4A. The policy execution engine 4 acquires a file path and a policy execution count n of the policy target list file 14 (FIG. 5) to be executed from the setting information DB 12, and causes the policy execution unit 4A to execute the policy to the customers having a customer ID of an upper n-number of policy application priorities in the policy target list file 14.

The policy execution engine 4 adds, to the customer attribute data stored in the customer attribute DB 11, the execution result (compensation (or outcome); purchase amount of each month corresponding to the customer attribute of the policy execution target in this embodiment) of the policy acquired asynchronously with the policy execution (after the lapse of a given period of time) from the policy execution unit 4A. In other words, the policy execution engine 4 periodically stores, in the customer attribute DB 11, the actual results of purchase of products by each customer as the execution result of the marketing policy. The accumulated data is used in creating the subsequent learner.

(Overall Processing of Target Selection System S)

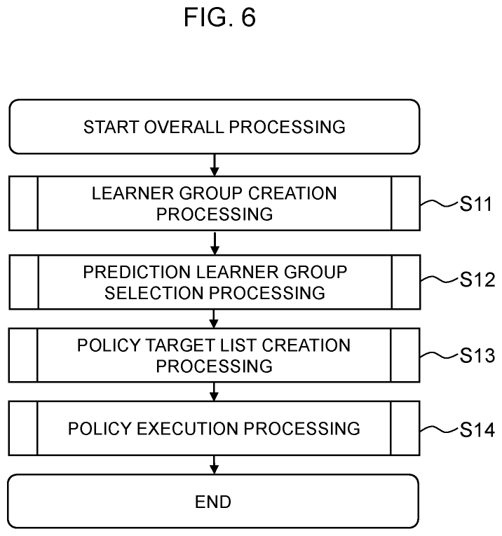

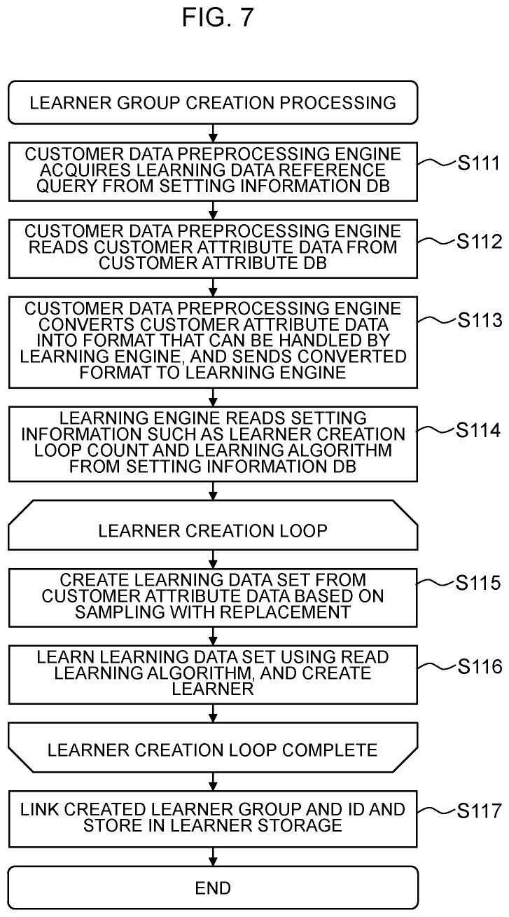

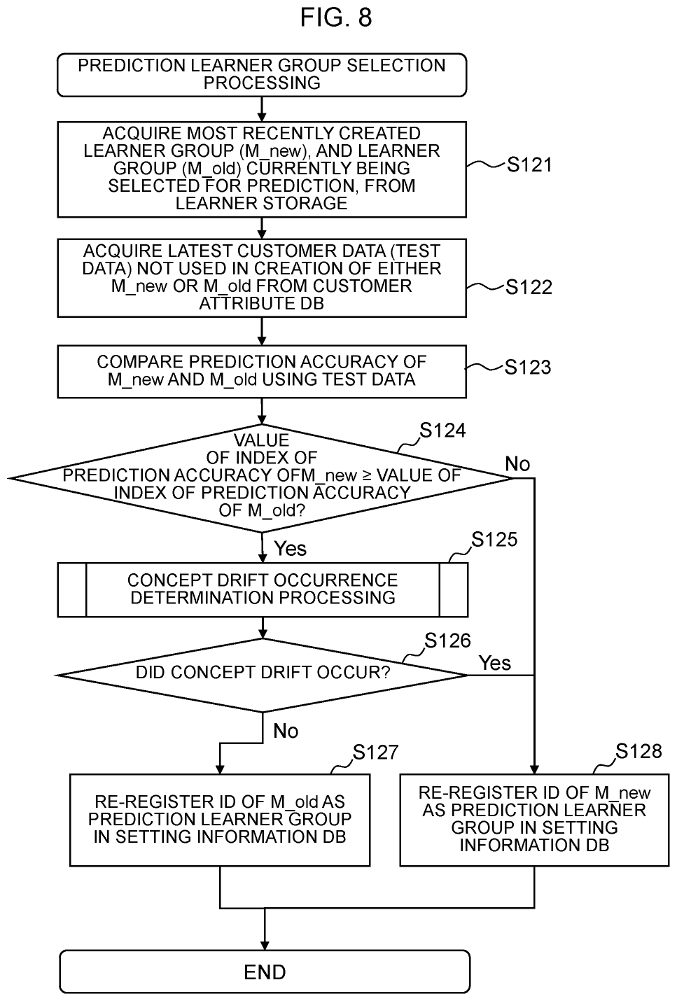

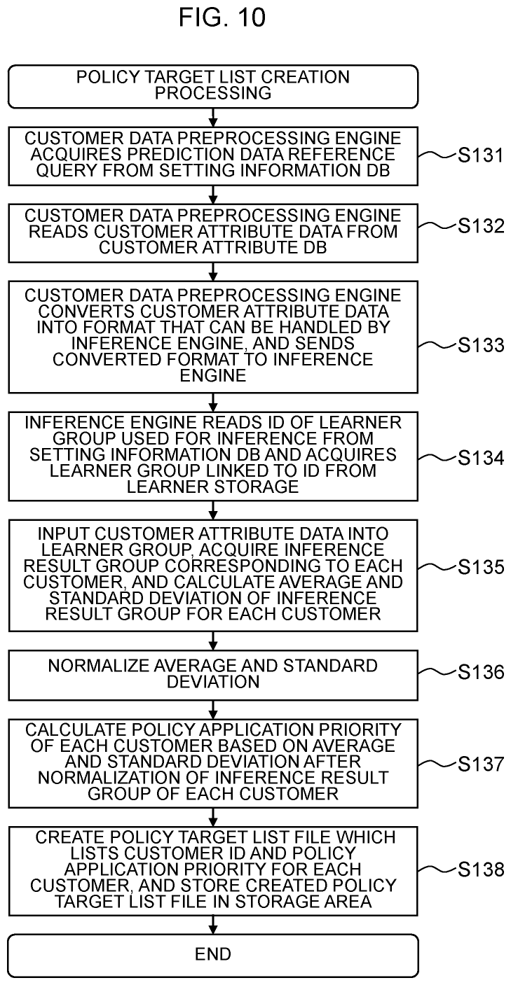

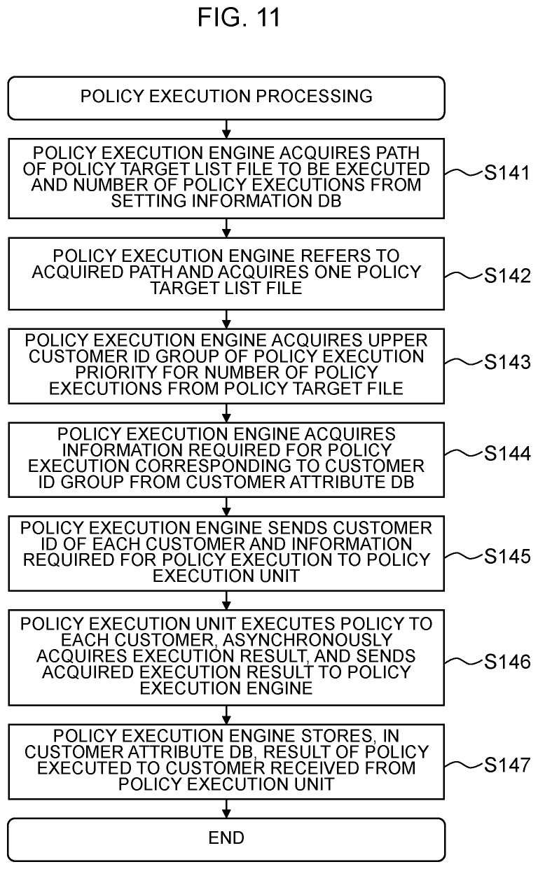

FIG. 6 is a flowchart showing an example of the overall processing of the target selection system S. In S11, the target selection system S executes the learner group creation processing (FIG. 7). Next, in S12, the target selection system S executes the prediction learner group selection processing (FIG. 8). Next, in S13, the target selection system S executes the policy target list creation processing (FIG. 10). Next, in S14, the target selection system S executes the policy execution processing (FIG. 11).

(Learner Group Creation Processing)

FIG. 7 is a flowchart showing an example of the learner group creation processing of S11 (FIG. 6). In S111, the customer data preprocessing engine 1 acquires a learning data reference query from the setting information DB 12. Next, in S112, the customer data preprocessing engine 1 reads customer attribute data from the customer attribute DB 11. Next, in S113, the customer data preprocessing engine 1 converts the customer attribute data read from the customer attribute DB 11 into a format (customer attribute data (for learning) 11D1) that can be handled by the learning engine 2, and sends the converted format to the learning engine 2.

Next, in S114, the learning engine 2 reads setting information such as the loop count N and the learning algorithm for creating the learner from the setting information DB 12.

Next, the learning engine 2 repeats the loop processing of S115 to S116 in the quantity of the loop count N for creating the learner read in S114.

In S115, the learning engine 2 creates, based on sampling with replacement of a predetermined number of records, a learning data set (customer attribute data (for learning) 11D1) from the customer attribute data stored in the customer attribute DB 11. Next, in S116, the learning engine 2 learns the learning data set (customer attribute data (for learning) 11D1) created in S115 by using the learning algorithm read in S114, and thereby creates a learner.

Each time S115 is executed, since the extracted record will differ and the created customer attribute data (for learning) 11D1 will differ, the learner created in S116 will also differ. Thus, as a result of the loop processing of S115 to S116 being repeated N-number of times, N-number of learner groups will be created.

When the loop processing of S115 to S116 is ended, in S117, the learning engine 2 links the learner group created in S116 with an ID and stores the learner group and the ID in the learner storage 13.

(Prediction Learner Group Selection Processing)

FIG. 8 is a flowchart showing an example of the prediction learner group selection processing of S12 (FIG. 6). Foremost, in S121, the policy target selection engine 3 acquires, from the learner storage 13, the learner group (M_new) created most recently (for example, one month ago) and the learner group (M_old) currently being selected for prediction.

Next, in S122, the customer data preprocessing engine 1 acquires, from the customer attribute DB 11, the latest customer data (test data) (for example, customer data (test data) for the most recent one month period) that has not been used in the creation of either M_new or M_old. Next, in S123, the policy target selection engine 3 uses the test data and performs predictions with each of M_new and M_old, and compares the values of the index of prediction accuracy of the obtained prediction result. As the index of prediction accuracy, an index such as the F value or RMSE (Root Mean Square Error) may be suitably selected according to the objective variable or the problem establishment of the prediction model. However, when an index such as the F value, which indicates that the prediction accuracy is high as its value is high, is selected, it is necessary to perform, immediately before the comparison of the prediction accuracy performed in S123, a calculation of appropriately converting a value so that the prediction accuracy becomes higher as the value is smaller such as by switching the positive/negative of the value or subtracting the corresponding value from the possible maximum value.

Next, in S124, the policy target selection engine 3 determines whether the value of index of prediction accuracy of M_new the value of index of prediction accuracy of M_old. When the value of index of prediction accuracy of M_new the value of index of prediction accuracy of M_old (S124; Yes), the policy target selection engine 3 proceeds to the processing of S125, and when the value of index of prediction accuracy of M_new <the value of index of prediction accuracy of M_old (S124; No), the policy target selection engine 3 proceeds to the processing of S128.

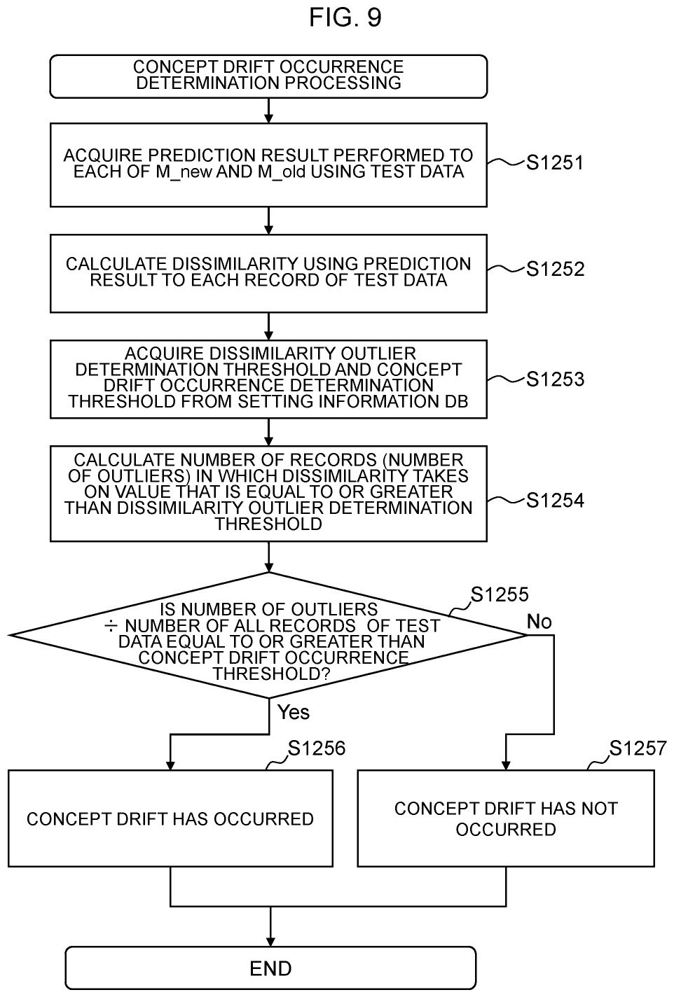

In S125, the policy target selection engine 3 executes the concept drift occurrence determination processing (FIG. 9). When a concept drift has occurred (S126; Yes), the policy target selection engine 3 proceeds to the processing of S128, and when a concept drift has not occurred (S126; No), the policy target selection engine 3 proceeds to the processing of S127.

In S127, the policy target selection engine 3 re-registers, in the setting information DB 12, the ID of M_old as the ID of the prediction learner group (or does not update the ID of M_old). In S128, the policy target selection engine 3 registers, in the setting information DB 12, the ID of M_new as the ID of the prediction learner group.

FIG. 9 is a flowchart showing an example of the concept drift occurrence determination processing of S125 (FIG. 8). Foremost, in S1251, the policy target selection engine 3 acquires the prediction result of the prediction performed with each of M_new and M_old using the test data acquired in S122.

Next, in S1252, the policy target selection engine 3 calculates the dissimilarity by using the prediction result of the prediction performed to each record of the test data. In S1252, when a set of prediction results using a record in which M_new is the i-th test data (for example, customer ID=i) is Y_new_i, and a set of prediction results based on M_old is similarly Y_old_i, the value of the dissimilarity function D (Y_new_i, Y_old_i) which assigns the dissimilarity to all i's is obtained.

The dissimilarity function D (Y_new_i, Y_old_i) is now explained. D (Y_new_i, Y_old_i) is defined in Formula (2). Formula (2) provides an index for obtaining the distance between clusters in the hierarchical clustering technique of the Ward's method.

D(Y_new_i, Y_old_i)=L (Y_new_i ∪Y_old_i)−i L (Y_new_i)−L (Y_old_i) (2)

The function L (X) in Formula (2) represents the sum of squares of the deviation for all factors of the set X. L (Y_new_i ∪Y_old_i) represents the sum of squares of the deviation for all factors of the sum set of the set Y_new_i and the set Y_old_i. L (Y_new_i) represents the sum of squares of the deviation for all factors of the set Y_new_i. L (Y_old_i) represents the sum of squares of the deviation for all factors of the set Y_old_i.

With the dissimilarity function D based on the definition of Formula (2), since the inference result based on the old and new models is stable and the model distance will increase as the estimation values based on the old and new models are spread apart, a concept drift can be properly detected when there is sufficient data in the corresponding region within the period of the old and new models.

Next, in S1253, the policy target selection engine 3 acquires, from the setting information DB 12, a dissimilarity outlier determination threshold Dout_th and a concept drift occurrence determination threshold (for example, 10%). Next, in S1254, the policy target selection engine 3 calculates the number of records (number of outliers) in which the dissimilarity calculated in S1252 takes on a value that is equal to or greater than the dissimilarity outlier determination threshold Dout_th.

Next, in S1255, the policy target selection engine 3 determines whether the calculation result of the number of outliers ÷ the number of all records of the test data is equal to or greater than the concept drift occurrence threshold (in this embodiment, 10%).

When the number of outliers ÷ the number of all records of the test data is equal to or greater than the concept drift occurrence threshold (S1255; Yes), the policy target selection engine 3 proceeds to the processing of S1256, and when the number of outliers ÷ the number of all records of the test data is less than the concept drift occurrence threshold (S1255; No), the policy target selection engine 3 proceeds to the processing of S1257.

For example, when the number of all records of the test data =1000 and the number of outliers in which the value of the dissimilarity function D is equal to or greater than the dissimilarity outlier determination threshold Dout_th is 120 outliers, since the ratio of the number of outliers will be 12% and is equal to or greater than the concept drift occurrence determination threshold (10%), it is determined that a concept drift has occurred.

In S1256, the policy target selection engine 3 determines that a concept drift has occurred. In S1257, the policy target selection engine 3 determines that a concept drift has not occurred.

(Policy Target List Creation Processing)

FIG. 10 is a flowchart showing an example of the policy target list creation processing of S13 (FIG. 6). Foremost, in S131, the customer data preprocessing engine 1 acquires a prediction data reference query from the setting information DB 12. Next, in S132, the customer data preprocessing engine 1 reads the customer attribute data from the customer attribute DB 11.

Next, in S133, the customer data preprocessing engine 1 converts the customer attribute data read from the customer attribute DB 11 in S132 into a format (customer attribute data (for prediction) 11D2) that can be handled by the inference engine of the policy target selection engine 3, and sends the converted format to the inference engine.

Next, in S134, the inference engine of the policy target selection engine 3 reads the ID of the learner group for inference from the setting information DB 12, and acquires the learner group linked with the ID from the learner storage 13. Next, in S135, the inference engine of the policy target selection engine 3 inputs the customer attribute data into the learner group acquired in S134, acquires the inference result group corresponding to each customer, and calculates the average and standard deviation of the inference result group for each customer.

Next, in S136, the policy target selection engine 3 normalizes the average and standard deviation calculated in S135. Next, in S137, the policy target selection engine 3 calculates the index according to the normalized average and standard deviation of the inference result group of each customer based on Formula (1), and uses the obtained index value as the policy application priority of each customer.

Next, in S138, the policy target selection engine 3 creates a policy target list file listing the customer ID and policy application priority of each customer, and stores the created policy target list file in the storage area.

(Policy Execution Processing)

FIG. 11 is a flowchart showing an example of the policy execution processing of S14 (FIG. 6). Foremost, in S141, the policy execution engine 4 acquires a path and a policy execution count n of the policy target list file 14 to be executed from the setting information DB 12. Next, in S142, the policy execution engine 4 refers to the path acquired in S141 and acquires one policy target list file 14.

Next, in S143, the policy execution engine 4 acquires, from the policy target list file 14, the customer ID group of an upper n-number of policy execution priorities corresponding to the policy execution count n. Next, in S144, the policy execution engine 4 acquires, from the customer attribute DB 11, information required for the policy execution corresponding to the customer ID group acquired in S143 (for example, information such as the email address or street address to which the DM is to be sent).

Next, in S145, the policy execution engine 4 sends, to the policy execution unit 4A, the customer ID of each customer and information required for the policy execution. Next, in S146, the policy execution unit 4A executes the policy (for example, sending of a DM) to each customer, acquires the execution result asynchronously (at a timing that is not immediately after the policy execution), and sends the acquired execution result to the policy execution engine 4. Next, in S147, the policy execution engine 4 stores, in the customer attribute DB 11, the result of the policy executed to the customer received from the policy execution unit 4A.

(Effect of This Embodiment)

In the embodiment described above, the compensation (average) predicated based on the attribute variables is used as the KPI (Key Performance Index) in the space formed by the attribute variables of the target (customer), the target is selected in ascending order from the highest policy application priority which gives consideration to the level and uncertainty (variance) of the KPI, and the policy is thereby executed. Since the probability distribution, which is pursuant to the compensation according to the customer attribute, is estimated using a means known as bagging which generates a plurality of learners, the processing load is light. New customers can be cultivated by targeting customers having few successful examples (small variance) in the past, but having a high success rate (average), and the compensation of the policy execution can be increased.

When calculating the prospect and uncertainty of the policy compensation, the average and variance of a plurality of predicted values predicted using each of a plurality of learners are used. By adopting the foregoing method, the prediction of the average and standard deviation of the compensation, which could not be realized with conventional methods which involve a large amount of calculation such as in Bayesian estimation, can be realized with lighter calculation.

In other words, the discovery of a range in which the policy compensation is high and the confidence is low in the space formed by the attribute variables of the target customer and the improvement in accuracy of the compensation prediction of such range can be realized with a method that is lighter and more efficient in comparison to conventional methods.

Moreover, as a coefficient a of the weighted average of the average and variance of the predicted value upon calculating the policy application priority, the coefficient a is obtained wherewith, among the upper M1-number of customers of the policy application priority of Formula (1), the number of customers not included in the upper M2-number of customers of the average (normalized) of the predicted value of the purchase amount of the current month will be within p % of the total number of customers (total number of lines of the policy target list file 14). This coefficient a may be used in the subsequent calculation of the policy application priority onward. It is thereby possible to evaluate the appropriateness of the policy application priority and provide a feedback of the evaluation result.

Moreover, when the prediction accuracy of the learner group deteriorates or a concept drift is detected, the new learner group created using the new customer attribute data is updated. The policy is executed to the new target according to the policy application priority based on the prediction result from the new learner group. The execution result of the policy is thereafter stored in the customer attribute data.

Accordingly, since the target is decided based on the latest learner group created using the latest customer attribute data (for learning) 11D1 and the prediction result using the latest customer attribute data (for prediction) 11D2, it is possible to eliminate the useless selection of policies, and execute a more appropriate policy.

(Modified Example)

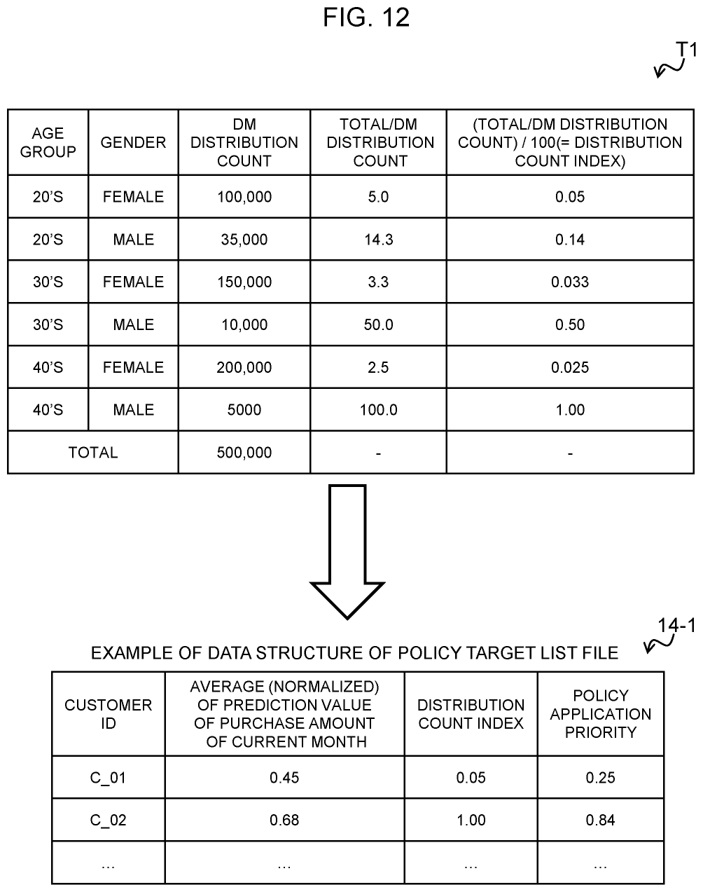

In the embodiment described above, the standard deviation (normalized) is used as the evaluation index (confidence) representing the uncertainty (low level of confidence) of prediction. Nevertheless, without limitation thereto, a different evaluation index of uncertainty of prediction can also be considered. A different evaluation index of uncertainty of prediction is now explained as a modified example. FIG. 12 is a diagram showing the data structure of the policy target list file 14-1 of the modified example.

For example, an evaluation index (distribution count index) based on the DM distribution count of each customer attribute (age group and gender) may also be used as the index of uncertainty of prediction. As shown in the distribution count index table T1 of FIG. 12, it is possible to total the DM distribution count for each group obtained based on the combination of age group and gender, and create an index (distribution count index) in which the prediction can be deemed uncertain as the DM distribution count is smaller.

In light of the purport of this embodiment of executing the policy to a customer in which the uncertainty of prediction is high and approaching such customer in order to cultivate customers of an uncharted segment, a customer in which the uncertainty of prediction is high will be a customer of an uncharted segment. Thus, since the customer will be a customer of an uncharted segment as the DM distribution count is smaller, defined is a distribution count index in which the uncertainty is high as the DM distribution count is small and the uncertainty is low as the DM distribution count is great.

In the policy target list file 14-1 of the modified example, this distribution count index is adopted in substitute for the “standard deviation (normalized) of the predicted value of the purchase amount of the current month” of the policy target list file 14 in the embodiment explained above, and the policy application priority is thereby calculated.

Without limitation to the variance of the predicted value, another index may be used as the index which indicates the uncertainty of prediction.

(Hardware of Computer 500)

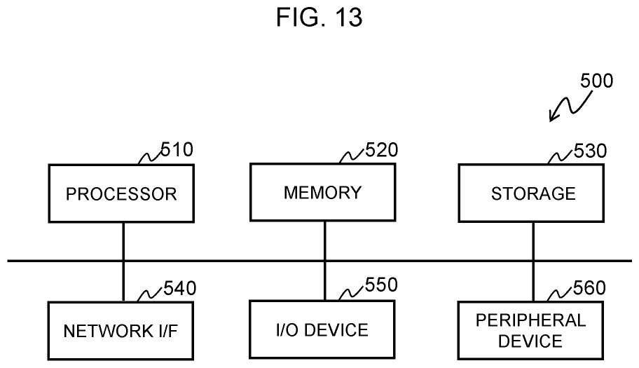

FIG. 13 is a diagram showing a hardware configuration example of the computer 500. FIG. 13 is a diagram showing the hardware of the computer which realizes a target selection system S and each of a customer data preprocessing engine 1, a learning engine 2, and a policy target selection engine 3. In the computer 500, a processor 510 such as a CPU (Central Processing Unit), a memory 520 such as a RAM (Random Access Memory), a storage 530 such as an SSD (Solid State Drive) or an HDD (Hard Disk Drive), a network I/F (Inter/Face) 540, an I/O device 550 (for example, keyboard, mouse, touch panel, or display), and a peripheral device 560 are connected via a bus.

In the computer 500, each system is realized by the programs for realizing the target selection system S and the respective engines being read from the storage 530 and executed through coordination of the processor 510 and the memory 520. Otherwise, the respective programs for realizing the target selection system S and the respective engines may also be acquired from an external computer through communication via the network I/F 540. Otherwise, the respective programs may also be acquired by being recorded in a non-temporary recording medium and read by a medium-reading device.

The foregoing embodiment was explained in detail for describing the present invention in an easy-to-understand manner, and the present invention does not need to necessarily comprise all of the configurations explained in the embodiment. Moreover, in the multiple embodiments and modified examples explained above, devices or system configurations may be changed or certain configurations or processing routines may be omitted, replaced or combined to the extent that the subject matter of the present invention is not changed. Furthermore, in the functional block diagrams and hardware diagrams, control lines and information lines are illustrated to the extent required for explaining the present invention, and not all control lines and information lines may necessarily be indicated. In effect, it may be understood that nearly all of the configurations are mutually connected.

### REFERENCE SIGNS LIST

S: target selection system, 1: customer data preprocessing engine, 1A: policy execution unit, 2: learning engine, 3: policy target selection engine, 4: policy execution engine, 4A: policy execution unit, 11: customer attribute DB, 12: setting information DB, 13: learner storage, 14, 14-1: policy target list file, 500: computer

1. A target selection system which selects a target to which a policy is to be executed, comprising:
a learner generation unit which generates, as a learner group, a plurality of learners that learned a correspondence of an attribute and an outcome in each of a plurality of learning data sets extracted from a data group associated with an attribute and an outcome of each of the targets; and
a target selection unit which applies the learner group selected for inference to an inference data set extracted from the data group and predicts, for each of the learners, an outcome corresponding to an attribute in the inference data set, calculates, for each attribute in the inference data set, at least one of either an average of the outcomes predicted for each of the learners or an index value expressing an uncertainty of the outcomes, and selects, from the inference data set, the target to which the policy is to be executed based on at least one of either the calculated average or the calculated index value.

2. The target selection system according to claim 1,
wherein the index value is a standard deviation of each of the attributes of the outcomes corresponding to the attribute in the inference data set predicted for each of the learners.

3. The target selection system according to claim 1,
wherein the target selection unit selects the target based on the average of each of the attributes and a weighted average of the index value.

4. The target selection system according to claim 3,
wherein the target selection unit:
calculates a coefficient of the weighted average wherewith, in the inference data set, a number of the targets in which the average is not included in an upper second number among the targets in which the weighted average is included in an upper first number will be within a predetermined ratio relative to a number of all records of the inference data set; and
selects the target based on the weighted average using the coefficient in selecting the target next time onward.

5. The target selection system according to claim 1, further comprising:
a policy execution unit which executes the policy to the target selected by the target selection unit.

6. The target selection system according to claim 5,
wherein the policy execution unit stores an outcome obtained by executing the policy to the target selected by the target selection unit by associating the outcome with an attribute of the target in the data group.

7. The target selection system according to claim 1,
wherein the target selection unit compares a first prediction accuracy related to a first outcome predicted by applying the learner group before being selected for inference, which was recently generated by the learner generation unit, to a test data set extracted from the data group, and a second prediction accuracy related to a second outcome predicted by applying the learner group currently being selected for inference, and, when the first prediction accuracy exceeds the second prediction accuracy, selects the learner group which predicts the first outcome for inference.

8. The target selection system according to claim 7,
wherein, when the first prediction accuracy is equal to or less than the second prediction accuracy, the target selection unit determines whether a concept drift has occurred in the learner group which predicts the second outcome based on the first outcome and the second outcome that were predicted, and, when a concept drift is occurring, selects the learner group which predicts the first outcome for inference.

9. A target selection method performed by a target selection system which selects a target to which a policy is to be executed, comprising the steps of:
generating, as a learner group, a plurality of learners that learned a correspondence of an attribute and an outcome in each of a plurality of learning data sets extracted from a data group associated with an attribute and an outcome of each of the targets; and
applying the learner group selected for inference to an inference data set extracted from the data group and predicting, for each of the learners, an outcome corresponding to an attribute in the inference data set, calculating, for each attribute in the inference data set, at least one of either an average of the outcomes predicted for each of the learners or an index value expressing an uncertainty of the outcomes, and selecting, from the inference data set, the target to which the policy is to be executed based on at least one of either the calculated average or the calculated index value.

10. A non-transitory computer-readable recording medium for storing a target selection program for causing a computer to function as a target selection system which selects a target to which a policy is to be executed, wherein the target selection program causes the computer to function as:
a learner generation unit which generates, as a learner group, a plurality of learners that learned a correspondence of an attribute and an outcome in each of a plurality of learning data sets extracted from a data group associated with an attribute and an outcome of each of the targets; and
a target selection unit which applies the learner group selected for inference to an inference data set extracted from the data group and predicts, for each of the learners, an outcome corresponding to an attribute in the inference data set, calculates, for each attribute in the inference data set, at least one of either an average of the outcomes predicted for each of the learners or an index value expressing an uncertainty of the outcomes, and selects, from the inference data set, the target to which the policy is to be executed based on at least one of either the calculated average or the calculated index value.
